(19) United States
(12) Patent Application Publication
(10) Pub. No.: US 2021/0028624 A1
(43) Pub. Date: Jan. 28, 2021

(54) METHOD AND DEVICE FOR CONTROLLING AN ELECTRIC VOLTAGE

(71) Applicant: SIEMENS AKTIENGESELLSCHAFT, MUENCHEN (DE)

(72) Inventors: Jürgen LOTTES, NUERNBERG (DE); Heinrich VON GEYMUELLER, NUERNBERG (DE); Joachim STEINKOHL, AALBORG (DK)

(21) Appl. No.: 16/980,510

(22) PCT Filed: Feb. 22, 2019
(86) PCT No.: PCT/EP2019/054465

§ 371 Date: Sep. 14, 2020

(30) Foreign Application Priority Data
Mar. 12, 2018 (DE) 102018203677

(51) Int. Cl. H02J 3/16; H02J 3/20

(52) U.S. Cl. CPC H02J 3/16; H02J 3/20

(57) ABSTRACT

A method and a device control a voltage of a power grid by use of a reactive power device connected to the power grid. The method includes: determining a change over time of a previous voltage of the power grid, determining a change over time of a reactive power previously output into the power grid by the reactive power device, and subsequently outputting reactive power into the power grid by the reactive power device, which reactive power is determined in dependence on the changes over time.

The present invention relates to a method and a device for controlling an electric voltage of a power grid by means of a reactive power device. In particular, the present invention relates to a method for adjusting the speed of an installation for the control of voltage in a high-voltage grid by means of compensation or the injection of reactive power, and further relates to a method for determining a network short-circuit equivalent, in consideration of other FACTS installations which are in electrical proximity in the grid.

At various stations on a high-voltage transmission line of a high-voltage grid, or at various points on a medium-voltage grid or in a transformer substation, it can be necessary to provide reactive power devices or voltage control elements, which are designed to regulate the voltage on the respective grid or grid section to a predefined voltage. To this end, it can be necessary to inject reactive power, i.e. power, the current and voltage of which are phase-displaced through 90°, into said grid or grid section.

A controller or control function of a fast-response voltage control element (the step response of a SVC/SVC PLUS can be e.g. of the order of 40 ms) must adjust its setting values (particularly control parameters) to changes in the electricity transmission grid. To this end, the controller is required to determine the short-circuit power of the grid. If the power on the grid has reduced during operation (due to a stronger drop in load, e.g. at night), the controller is required to respond to a control deviation with a reduction in output power. If the short-circuit power of the grid is thus reduced, the voltage control element, particularly the reactive power device, is required to deliver less reactive power to the grid in order to restore the target voltage which would be present, were the short-circuit power higher. Otherwise, the controller would respond too rapidly (or too strongly), potentially resulting in the unstable behavior of the installation, as a result of which, in particular, oscillations might be induced. Conversely, if the power on the grid increases (e.g. in response to the run-up of large power plants), the controller must then execute a stronger response to a control deviation than previously, in the event of lower power, or the installation would not otherwise achieve the specified transient recovery time. If the short-circuit power of the grid is thus increased, the voltage control element or the reactive power device is then required to inject more reactive power into the grid in order to restore the voltage to the desired target voltage than would be the case, were the short-circuit power lower.

Moreover, further voltage control elements can be present in the grid which, in turn, respond to voltage fluctuations. Consequently, the controller of the voltage control element is additionally required to identify a response to a voltage variation, and particularly the injection of reactive power, by further fast-response voltage control elements in the locality, as the latter will also endeavor to execute voltage control in the event of a voltage variation on the grid. Therefore a plurality of dynamically operating control installations can simultaneously change the voltage of the grid. It is therefore not necessary for each individual installation to restore the voltage to the desired target voltage, but only to restore a specific proportion thereof. Consequently, the controller is required to respond less rapidly (or to a lesser extent) to a voltage deviation, in comparison with operation in the absence of further fast-response voltage control elements.

Conventional reactive power compensation installations can increase their output power in a series of repeated cycles for a given time, and measure the resulting influence upon the system voltage. The variation in output power can be executed e.g. for 200 ms, and the process can be cyclically repeated e.g. every 12 hours. During measurements of short-circuit power according to the conventional method, other voltage control elements, particularly reactive power compensation installations, are frozen at their most recent working point for the duration of testing or the measurement of short-circuit power, such that other reactive power compensation installations, or voltage control installations in general, do not execute any control during testing or during the measurement of short-circuit power. As a result, the influence of other installations upon the calculation of short-circuit power can be eliminated.

However, the conventional method can only be applied if communication with other installations is in place. Moreover, intervention in the control executed by said other installations is required, particularly the suspension of control for a given time. Additionally, the conventional method can only be implemented in practice where installations are still under construction, as the implementation of this method requires a direct intervention in the control structure of the installation.

One object of the present invention is thus the provision of a method and a device for controlling an electric voltage of a grid, wherein control is improved and the method is simple to implement. It is further intended that the complexity of communication should be reduced. Practical feasibility is also substantially facilitated.

This object is fulfilled by the subject matter of the independent claims, which address a method or a device for controlling an electric voltage. The dependent claims specify particular forms of embodiment of the present invention.

According to one form of embodiment of the present invention, a method is provided for controlling an electric voltage of a grid by means of a reactive power device which is connected to the grid (at an electrical connecting point), wherein the method comprises the following: determining a change over time of a previous voltage on the grid (e.g. at the connecting point); determining a change over time of a reactive power previously output into the grid by the reactive power device; and thereafter: outputting of a reactive power into the power grid by means of the reactive power device, which reactive power is determined in accordance with said changes over time.

The grid can be a high-voltage grid, a medium-voltage grid or a low-voltage grid. The grid can be a three-phase AC voltage grid. The reactive power device can be designed to supply and/or absorb reactive power to or from the grid.

Reactive power (e.g. capacitive or inductive) is power in which the current and voltage are phase-displaced through 90°. The method can be configured such that the electric voltage on the grid is controlled to a target grid voltage. If, for example, the electric voltage of the grid is lower than the target voltage, the reactive power device can be prompted to inject (particularly capacitive) reactive power into the grid, wherein e.g. capacitive reactive power is injected, in which the current leads the voltage by 90°.

For example, at least two previous voltages (i.e. voltages present on the grid at different previous time points) can be determined by voltage measurement, e.g. on one phase, two phases, or all three phases. In particular, a plurality of previous voltages can be scanned in specific time intervals or in a specific time interval. The change over time of the previous voltage can then be determined as a differential in two previous voltages which have been measured at different time points, wherein said time points can differ e.g. by approximately 1 ms.

The reactive power device can be a device or an installation, particularly a reactive power compensation installation, which is capable of generating and/or absorbing reactive power.

Reactive power which has previously been output into the grid by the reactive power device can be determined at the same time points which have been employed for the determination of the previous voltages. The change over time in reactive power which has previously been output into the grid can also be calculated as a differential in two previously outputted and measured reactive powers, which relate to two different previous time points.

During the method, the reactive power device is not necessarily required to output a changed reactive power for a specific time or for a specific time interval, for the sole purpose of determining a short-circuit power of the grid. Instead, the method can be executed during the standard and routine operation of the reactive power device or of a controller of the reactive power device. Control can be executed in accordance with standard operation of the reactive power device, wherein e.g. a differential between the electric voltage and the target voltage is fed to a controller, e.g. a PI controller, which calculates a reference value for reactive power from the latter, which is fed to the reactive power device, whereafter the reactive power device injects the corresponding reactive power into the grid, such that the error difference between the electric voltage on the grid and the target voltage is reduced, and particularly is set to zero.

Reactive power which is output from the reactive power device into the grid is output at a time point which temporally succeeds the previous voltage, which is measured at a previous time point, and which succeeds the reactive power which has previously been output into the grid, and which has been output at a previous time. Thus, from the changes over time of the grid voltage and from the reactive power output into the grid at previous time points, it is possible to determine the reactive power which is to be injected into the grid at a later time point, in order to counteract any deviation of the voltage from the target voltage.

During the method, it is not necessary for other control devices in electrical proximity, particularly reactive power compensation devices, to be disabled or frozen with respect to their control function. Communication with other control installations during the method is thus not necessary.

According to one form of embodiment of the present invention, the method is configured such that the output of reactive power which is subsequently delivered by the reactive power device comprises the following: setting of at least one controller parameter, particularly a controller amplification, on a controller of the reactive power device in accordance with changes over time, wherein the controller receives a deviation of the previous grid voltage from a target value as an input; outputting by the controller of a control value for reactive power to a converter of the reactive power device; generation of reactive power by the converter and injection into the grid.

Outputting of reactive power is executed after the changes over time in the grid voltage and the output of reactive power at previous time points have been determined.

The controller can be e.g. a PID controller, wherein an integration branch, a proportional branch and a differential branch, with respective parameters, can be present. Reactive power can be determined e.g. depending upon whether changes over time exceed specific threshold values and/or whether changes over time carry the same or a different symbol. The converter itself can incorporate a power supply, and can be configured to output a desired reactive power, at a desired voltage and frequency, into the grid. To this end, a thyristor-controlled reactor and a capacitor (SVC Classic) or a converter actuated by means of power electronics (SVC PLUS) can be employed. However, the method is not dependent upon the type of reactive power compensation employed, and can be generally employed in installations which deliver fast-response voltage control (in the region of 100 ms). A multi-level converter can be employed. The controller of the reactive power device delivers the control value for reactive power as an output to the converter which, in particular, can be provided with a driver circuit which, on the basis of the control value for reactive power, generates pulse-width modulation signals, which can be fed to the gates of the power transistors. Power transistors can be arranged between different phases of the reactive power device, in a manner which is known from the prior art. Consequently, the method also supports conventionally available electronic components.

Controller amplification can correspond to the controller speed. The controller speed can optimally be set such that the speed fulfills specific conditions at all times. These conditions are e.g. as follows: 90% of a target value step is achieved in 40 ms, with a maximum overshoot of 10%. The speed of a controller can be measured or defined accordingly.

According to one form of embodiment of the present invention, the setting of at least one controller parameter comprises the following: determination of a previous short-circuit power on the grid, in accordance with changes over time; and determination of the controller parameter on the basis of the previous short-circuit power determined. Thus e.g. the speed of the controller can be adjusted. Two factors can be considered for this purpose, namely, the short-circuit level in the grid and the influence of other voltage controllers in the grid (e.g. other reactive power compensation installations).

The previous short-circuit power can be understood as that short-circuit power which was present at the previous time points at which the voltage and reactive power were also determined, or the changes therein over time were determined. Short-circuit power can be determined e.g. by a relationship of the system voltage with reactive power. An approximation between the change in reactive power and the change in voltage can be employed in order to approximate the short-circuit power of the grid. In theory, the short-circuit power of the grid can be derived from the present grid impedance and the present system voltage on sources in the grid. The mathematical relationship between the change in the system voltage and the change in reactive power can be an approximation. If both variables are calculated dynamically (by rapid calculation, approximately every 1 ms), a controller amplification can be determined which considers both the present short-circuit power of the grid and the influence of other installations. This means that both factors influence the result of measurement.

According to one form of embodiment of the present invention, the method is configured such that the previous short-circuit power of the grid is determined in accordance with a respective magnitude and/or symbol of the previous changes over time of the voltage on the grid and the previous change over time in the reactive power output of the reactive power device, and particularly on the basis of a further previously determined short-circuit power of the grid.

It can be critical that, by a comparison of the symbol of the change in reactive power (in this case, the term “inductive” signifies “negative”) and the change in voltage (negative signifies a reduction in voltage), it can be determined whether the SVC (generally the reactive power device) itself contributes to the change in voltage. If this is not the case, measured values can be discarded on the grounds that, in this case, no relationship between the intrinsic injection or take-up of reactive power and the system voltage can be established.

If e.g. the magnitude of the change over time in voltage or reactive power is lower than respective threshold values, any such measurement can be discarded, as measured values can be attributed to interference or noise. The further previously determined short-circuit power relates to a short-circuit power which was temporally present prior to the previous time points. If e.g. a measurement of the change over time in voltage and reactive power has been discarded on the grounds of insufficient magnitude, the previous short-circuit power can be equated to the further previously determined short-circuit power. The same procedure can apply, if the sign of the change over time in voltage differs from that of the change over time in reactive power. Stable control or regulation of the electric voltage is permitted accordingly.

According to one form of embodiment of the present invention, the method is configured such that the previous short-circuit power of the grid is determined in accordance with a previous relationship of the previous changes over time in the system voltage with the previous change over time in the reactive power output of the reactive power device, by the application of a determination logic which is particularly determined based upon a simulation.

Parameters for controller amplification can be, or can have been determined (beforehand) by reference to a real-time simulator using actual grid data. Moreover, tests can be, or can have been executed on an actual grid which indicate that values lie in the correct region.

The previous relationship constitutes a break between the previous change in voltage and the change in reactive power previously output into the grid, and thus relates to the previous time or previous times in which changes in the previous voltage or in reactive power previously output into the grid were determined. The determination logic can incorporate e.g. the magnitude and/or the symbol of the previous changes over time, and can mutually relate the latter or mutually offset the latter, without incorporating the previous relationship of changes over time itself. The determination logic can comprise, for example, a query function or a decision-making element, which establishes whether or not the magnitudes of voltage and reactive power exceed certain threshold values. A further query function or a further decision-making element can establish whether the symbols of the changes over time are the same or different. A simple implementation of the method can be provided accordingly.

According to one form of embodiment of the present invention, the determination logic incorporates a weighting of the previous relationship relative to the further previous short-circuit power which is higher, the greater at least one of the magnitudes of the changes over time in the previous system voltage and/or of the change over time in the reactive power previously output by the reactive power device, and/or employs the previous relationship or the weighted previous relationship for the determination of the previous short-circuit power, where a magnitude of the changes over time in the previous system voltage and/or of the change over time in the reactive power previously output by the reactive power device exceeds a respective threshold value and/or where a symbol of the change over time in the previous system voltage and a symbol of the change over time in the reactive power previously output by the reactive power device are the same, wherein the reactive power output by the reactive power device is subject to a rising valuation, in the event of the increasing injection of capacitive reactive power.

The previous relationship can thus be combined with the further previously determined short-circuit power, particularly in a weighted manner, depending upon the quantitative magnitude of the changes over time. The weighting factor can be set on the basis of appropriate simulations. The weighting factor can particularly be determined according to the magnitude of dispersions over time, wherein the weighting factor is higher, the greater the magnitude of at least one of the changes over time.

In one form of embodiment of the present invention, the method is configured such that the previous short-circuit power KSL_previous, where ΔQ/ΔV>0, is determined as follows:

KSL_previous=((1−w)*KSL_further-previous+w*ΔQ_previous/ΔV_previous)/2

where:

ΔV_previous is the change in the previous voltage on the grid

ΔQ_previous is the change over time in the reactive power previously output by the reactive power device

KSL_previous is the previous short-circuit power of the grid

KSL_further-previous is the further previous short-circuit power of the grid (i.e. the short-circuit power which was present prior to the previous short-circuit power of the grid), and

w is a weighting factor between zero and one.

A simple determination of the previous short-circuit power can thus be executed, and implemented in a simple manner.

According to one form of embodiment of the present invention, the method is configured such that ΔQ0, ΔV0 are threshold values, and

w=0, where ΔV<ΔV0 and/or ΔQ<ΔQ0

w=1, where ΔV>=ΔV0 and/or ΔQ>=ΔQ0

or

where w is proportional to (ΔQ−ΔQ0).

Other methods for determining the weighting factor w can be provided.

According to one form of embodiment of the present invention, the method is configured such that changes over time are determined in a time interval which lies between 100 μs and 10 ms, particularly between 500 μs and 5 ms, wherein the method is repeated continuously or cyclically.

Conventional methods can feature a response time of the order of 300 ms. According to one form of embodiment of the present invention, a short-circuit power of the grid is determined at cyclical time intervals, e.g. between 100 μs and 10 ms, the reactive power to be output thereafter is then determined, and is actually output into the grid. Accordingly, the method can very rapidly adjust the speed of voltage control to conditions in the grid, and particularly more rapidly than other installations which might also be present in the adjoining locality for the purposes of voltage control in the grid. It can thus be inherently achieved that the consideration of the influence of other installations in the grid can be incorporated into controller amplification for voltage control.

According to one form of embodiment of the present invention, a device is provided for controlling an electric voltage of a grid, wherein the device comprises the following: a controller, which is designed to determine a change over time in a previous voltage on the grid, and to determine a change over time in a reactive power which has previously been output into the grid by the reactive power device; and a reactive power device, which is connectable to the grid and is designed to output a reactive power into the grid which is determined in accordance with the changes over time.

In order to measure the present short-circuit capacity of the grid, including the influence of other fast-response voltage controllers, in a targeted manner at a specific time point, the above-mentioned method can be expanded. To this end, for a specific time (e.g. 300 ms), a fixed step can be added to the reactive power target value of the installation, with no suspension of the operation of the voltage controller. This can simulate a change in the system configuration (e.g. the switch-in of a static capacitor bank, which injects capacitive reactive power into the grid, when switched-in). The response of the controller and of other voltage controllers in the grid can then be further employed, according to the method described, in order to adjust controller amplification to the present system parameters.

It should be observed that features disclosed, explained or provided, whether individually or in any combination, in conjunction with a method for controlling an electric voltage of a grid can also be applied, whether individually or in any combination, to a device for controlling an electric voltage of a grid, according to forms of embodiment of the present invention, and vice versa.

Further advantages and features of the present invention proceed from the following exemplary description of currently preferred forms of embodiment. The individual figures in the drawing attached to the present application are to be considered as schematic only, and are not true to scale.

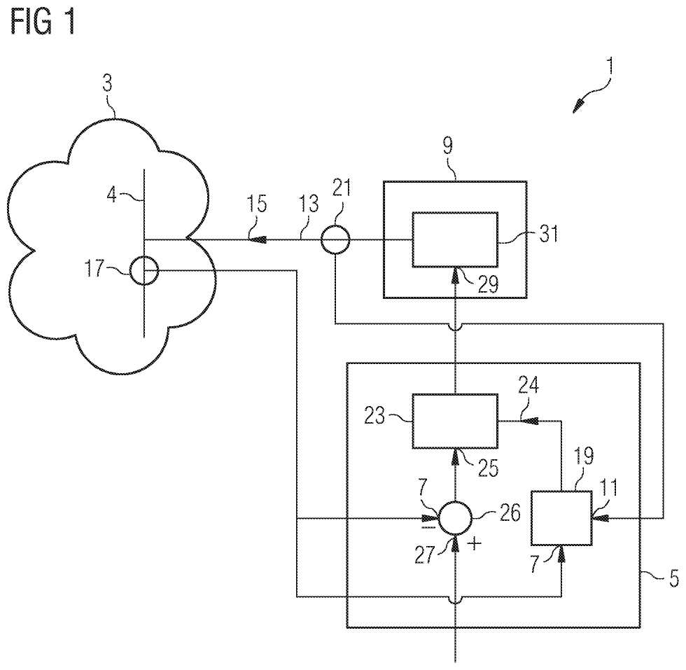

FIG. 1 shows a schematic illustration of a device for controlling an electric voltage, according to one form of embodiment of the present invention;

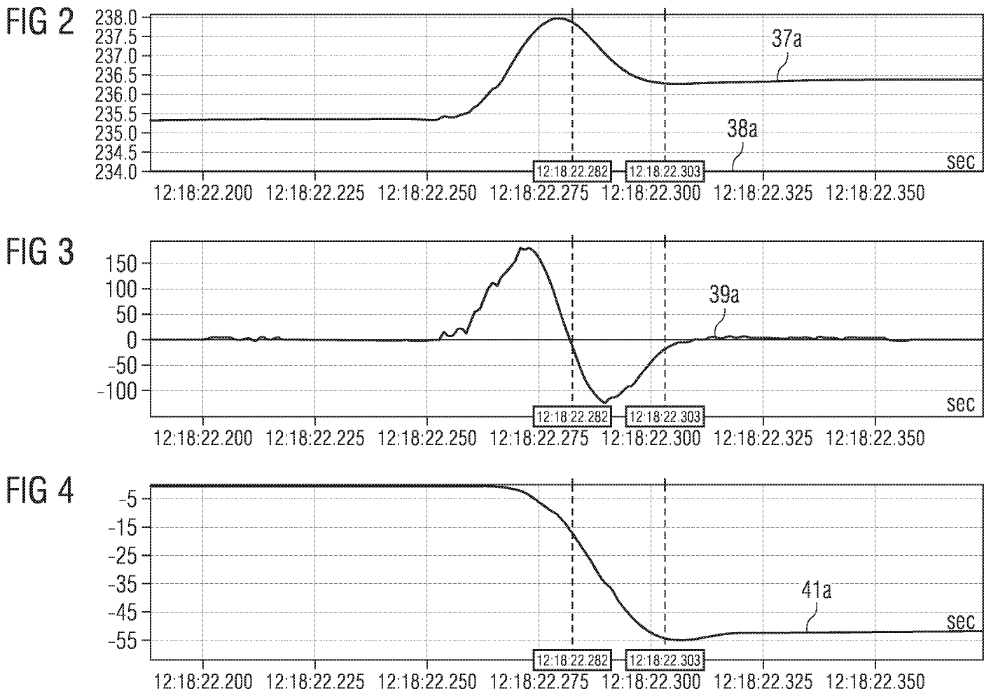

FIGS. 2 to 8 illustrate graphs of electrical variables which are determined, considered or adjusted, according to the form of embodiment of the present invention;

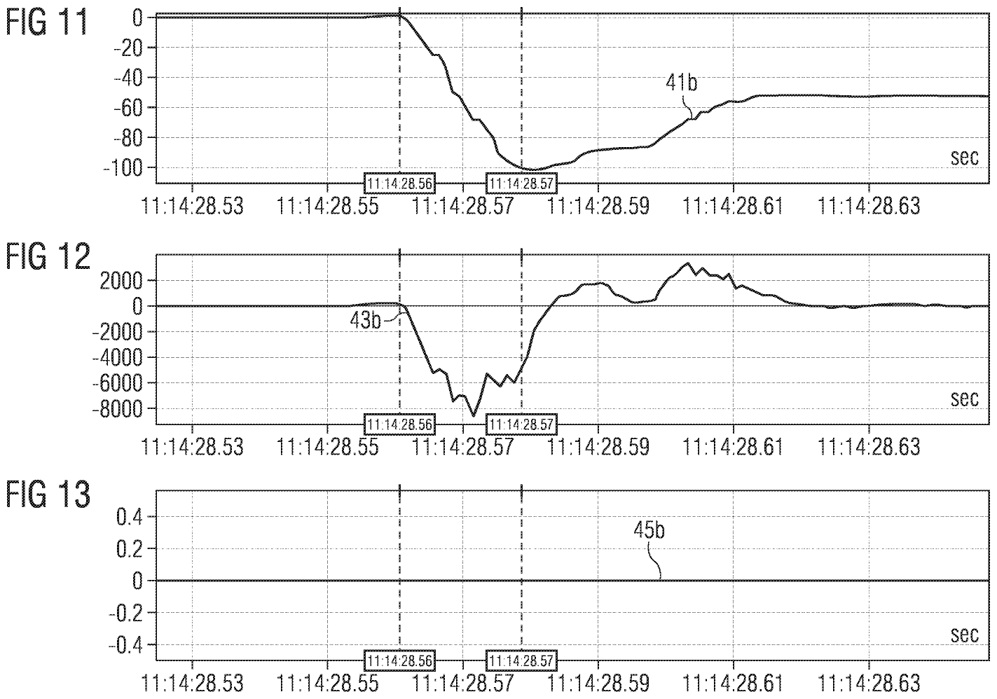

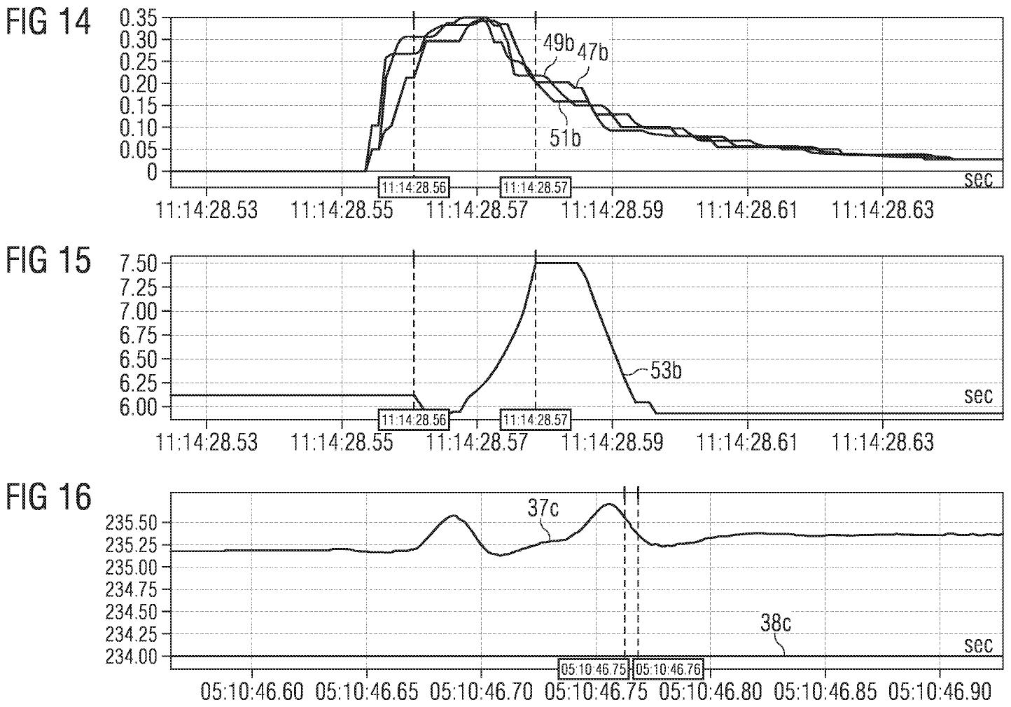

FIGS. 9 to 15 illustrate graphs of electrical variables which are determined, considered or adjusted, according to the form of embodiment of the present invention;

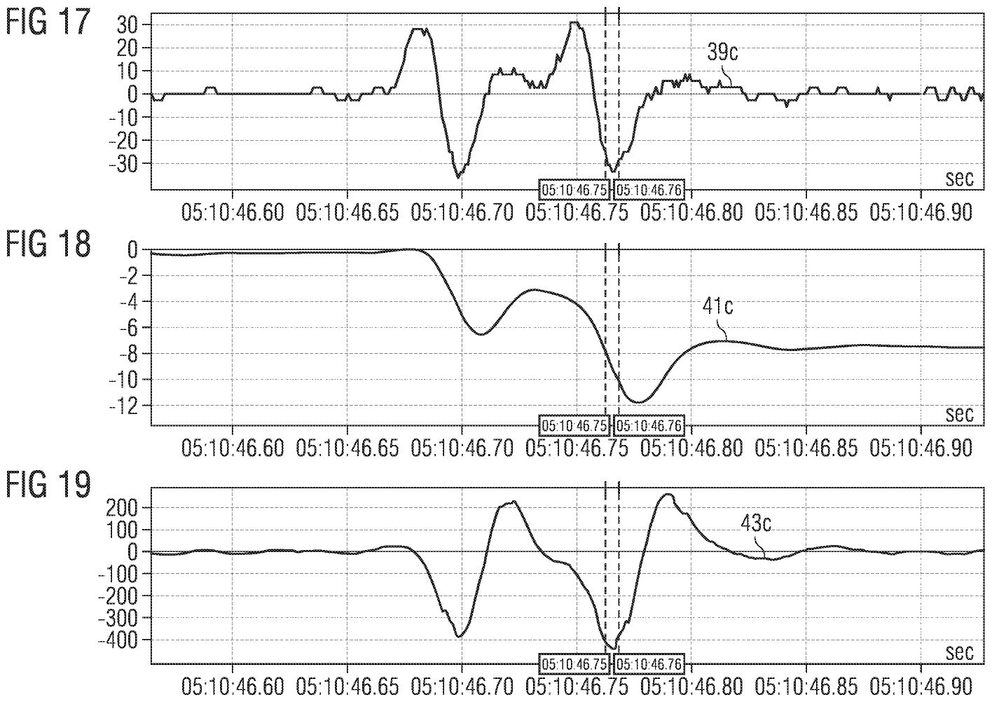

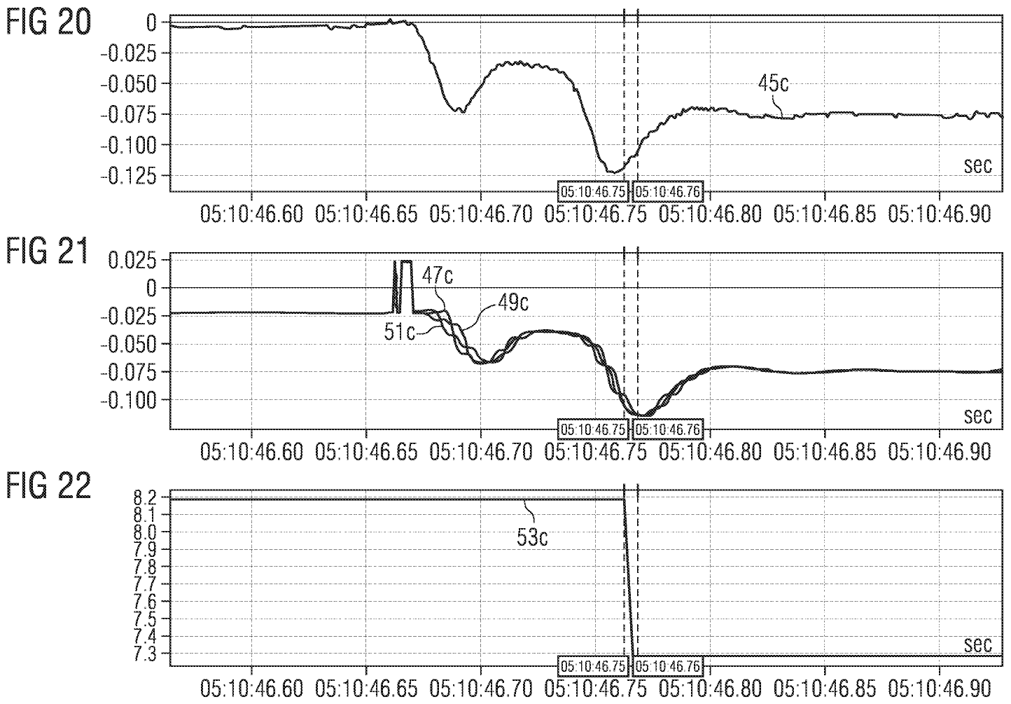

FIGS. 16 to 22 illustrate graphs of electrical variables which are determined, considered or adjusted, according to the form of embodiment of the present invention;

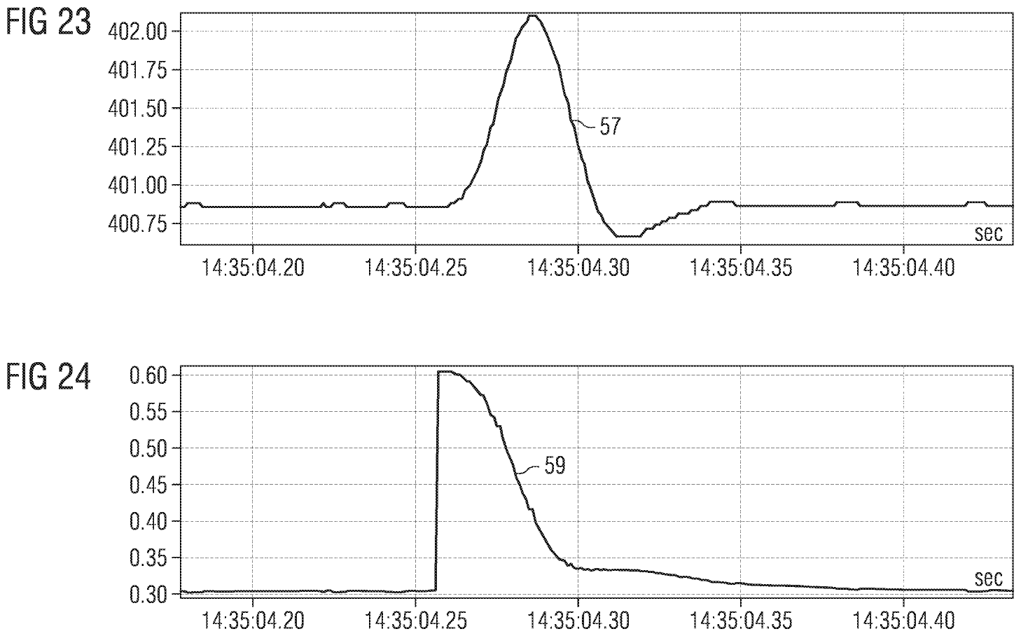

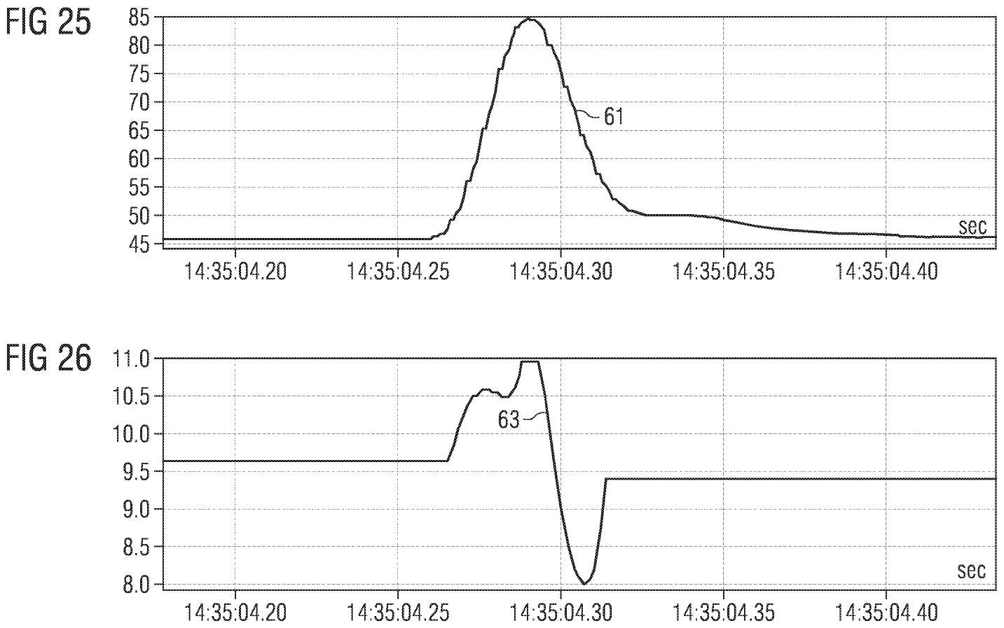

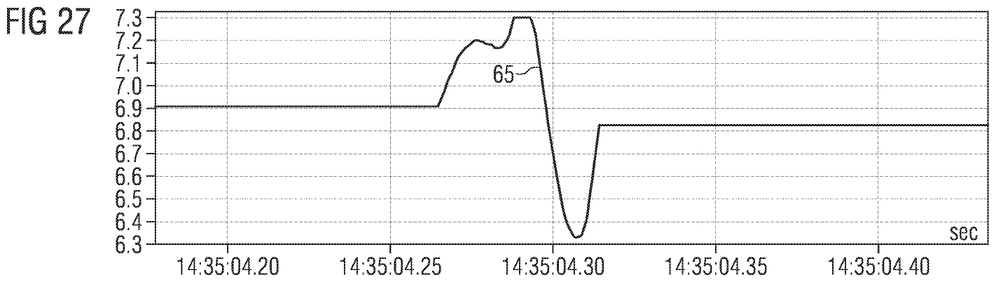

FIGS. 23 to 27 illustrate graphs of electrical variables which are determined, considered or adjusted, according to the form of embodiment of the present invention;

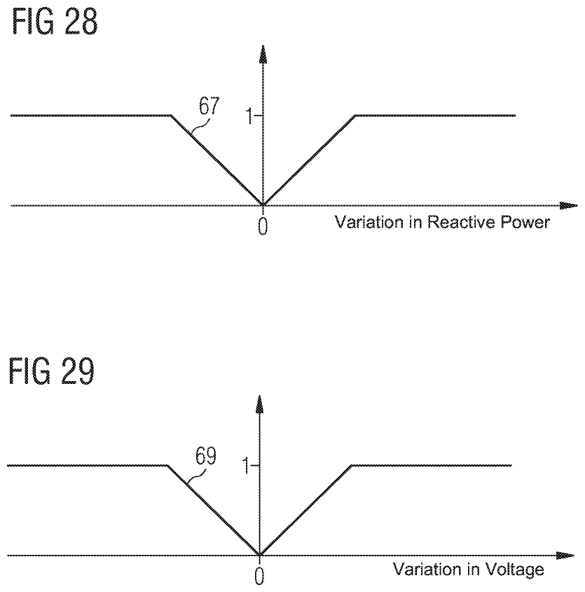

FIGS. 28 and 29 illustrate graphs of the output of reactive power or the system voltage, which are considered or adjusted according to forms of embodiment.

The device 1, which is schematically illustrated in FIG. 1, for controlling an electric voltage of a grid 3 according to one form of embodiment of the present invention comprises a controller 5, which is configured to determine a change over time in a previous voltage 7 on the grid 3, and to determine a change over time in a reactive power which has previously been output into the grid 3 by a reactive power device 9, as a measured value 11. The device 1 further comprises the reactive power device 9, which is connectable to the grid 3 and is particularly connected by means of a line 13, and is configured to output a reactive power 15 into the grid 3 via the connecting line 13 which is determined in accordance with changes over time in the previous voltage 7 and in the previous reactive power 11 which has been output into the grid 3.

The device 1 is particularly configured to execute a method for controlling an electric voltage of a grid by means of a reactive power device according to one form of embodiment of the present invention. By means of a measuring device or a measuring sensor 17, the voltage 7 on the grid is measured at a plurality of previous time points, particularly with a scanning frequency between 10 μs and 10 ms. From the plurality of previously measured voltages 7, the controller 5, particularly a determination module 19, determines the change over time in the previous voltage 7 on the grid 3. By means of a further measuring probe or a measuring device 21, reactive power or the previous reactive power output into the grid 3 by the reactive power device 9 at a plurality of previous time points is also measured, and is fed to the module 19 of the controller 5 as a measured value 11. On the basis of changes over time, the module 19 determines at least one controller parameter of the controller 23, and feeds this at least one controller parameter to the controller 23, e.g. a PID controller, by means of a signal 24.

As an input, the controller 23 receives a deviation 25 between a target voltage 27 (which e.g. is fed in from the exterior or can be saved in a memory of the controller 5) and the previous voltage 7 on the grid 3, wherein the deviation 25 is determined by means of a differential element 26. On the basis of the deviation 25, the controller 23 calculates a reference value 29 for reactive power, and feeds said reference value to a converter 31 of the reactive power device 9. The converter 31 can further comprise a gate driver circuit which generates gate driver signals for power transistors on the basis of the reference value 29 for reactive power.

In other forms of embodiment, a thyristor-controlled installation can be employed, which can comprise a thyristor stack with an inductance (a variable) arranged down-circuit, or a capacitor bank (SVC Classic engineering).

By the appropriate actuation of power transistors and/or thyristors, the converter 31 can generate and output a reactive power 15 into the grid which is defined according to the reference value 29 for reactive power. The requisite reactive power can be delivered within milliseconds.

The grid 3 can comprise e.g. a transmission line 4, for example a high-voltage transmission line. The device 1 can be arranged at various points within the grid 3, in order to permit the execution of voltage control in various regions of the grid 3.

The control structure illustrated in FIG. 1 and proposed according to this form of embodiment of the present invention can operate passively wherein, during the determination of the short-circuit power of the grid, an active variation of the output power (e.g. the reactive power output 15) is no longer necessary, but is still possible. The measured system voltage 7 and the measured power 11 of the operational equipment (current, power or reactive power) of the installation can be differentiated (in order to determine a change per unit of time). The relationship between these two changes over time can be employed as a measure of the short-circuit power of the electricity transmission grid (e.g. the grid 3). The short-circuit power thus calculated can be employed subject to specific criteria, but can also be discarded under specific conditions. A decision-making logic or calculation logic, depending upon the form of embodiment of the present invention, can be employed for this purpose. Other options can also be implemented.

According to forms of embodiment of the present invention, the decision-making or determination algorithm can incorporate two criteria:

The first criterion considers the magnitude of two dispersions, i.e. the dispersion of the voltage 7 on the grid and of the power 11 which is output or has been outputted by the reactive power device 9 into the grid. According to the calculation algorithm or logic (particularly fuzzy logic), it is decided whether the change in output power is caused by the change in voltage. If the output power of a reactive power compensation installation is predominantly capacitive, the system voltage must rise. If the output power is predominantly inductive, the system voltage must fall. Thus, according to one form of embodiment of the present invention, only the direction of change can or need be critical, but not the absolute value of the output power.

According to one form of embodiment of the present invention, fuzzy logic is employed for the determination of these two criteria. The input values are the change in power (the change over time in the voltage or the power output 15, or in the resulting measured value 11) and the change in voltage on the grid (i.e. the change over time in the system voltage 7). These values are then applied to formulae which state whether the input value rises or falls, and whether or not the magnitude thereof is significantly greater than zero. These values can then be mutually combined thereafter. A number between zero and one can thus be obtained, which can be considered as a weighting factor. A weighting value of one can indicate that the short-circuit value of the grid thus calculated is to be adopted. A weighting factor of zero can indicate that the calculated short-circuit value is not to be adopted, i.e. is to be discarded. For interim values, particularly where the weighting factor lies between zero and one, the short-circuit value can be proportionally calculated in combination with the further previously determined short-circuit value, and a weighted combined value can be saved and further employed for voltage control. For this selection logic, further options or forms of implementation can also be employed.

The logic function can or must monitor the controller output at all times. Only in this case is it rational for the previously calculated value to be considered. By means of the constant monitoring and triggers associated with fuzzy logic, in comparison with a conventional method, in which it is necessary for the controller to be disabled, a far greater number of measured values can be generated, and thus the quality of measurement can be successively improved. The consideration of previous measured values permits the combination of a plurality of measurements. In conventional methods, conversely, a measurement is only executed approximately once every 12 hours, as it is not desirable for the controller to be disabled frequently, on the grounds of the resulting reduction in the availability of the installation.

Any other interconnection of input parameters according to the above-mentioned two criteria is possible in order to arrive at this resolution of the issue. The selection logic can also be expanded to incorporate other parameters. Thus, the short-circuit power value can also be discarded, in the event of a substantial change in the system voltage associated with flashover in the electricity transmission grid. In particular, the voltage rise associated with the clearance of a grid fault is not caused by the installation, and is consequently not to be employed, according to this form of embodiment of the present invention. In particular, the method can provide particular advantages and can operate effectively in this case.

In order to permit the setting of the presently optimum controller amplification at any time point, in the absence of the occurrence of a change in the grid, a change in the grid can be simulated, independently of other components in the grid. To this end, a temporary step in the reactive power of the intrinsic converter can be generated. This step can function in the grid in the manner of a change associated with a switched element. The intrinsic measuring system can thus be triggered, and the controller amplification recalculated and reset.

By means of this solution, the present grid short-circuit power equivalent, incorporating the influence of other fast-response voltage controllers, can be determined at any time point.

An active grid test of this type can be initiated at any time point.

A combination of a conventional method and the method illustrated in the forms of embodiment of the present invention can also be executed. The short-circuit power (particularly the grid short-circuit equivalent) of the electricity transmission grid can thus be determined, and a correct response to other dynamic voltage control elements can be provided.

According to a form of embodiment of the present invention, changes over time in the system voltage and the change over time in output power are employed, and selection criteria and a logic function are applied for the execution of control.

A conventionally executed variation of the output power in order to determine a short-circuit power of the grid is not necessary according to the presently described method, but can be executed additionally in an optional manner. However, the calculation described is no longer restricted to a few cyclical measurements, but essentially can also be executed continuously, i.e. particularly in each pulse cycle. This can be advantageous in the event of a very substantial change in short-circuit power within a short time (e.g. in the event of a partial loss of the power grid), as the controller immediately calculates a new short-circuit power, and is thus not required to wait until a certain time has elapsed before a cyclical test is executed, or the system becomes unstable. Moreover, the influence of other dynamic voltage control elements can be considered at the same time. The proposed method can determine a lower short-circuit power value of the grid, and thus shows a reduced response to a voltage variation where another dynamic voltage control element is in electrical proximity and contributes to control. Thus, a stable control performance can also be achieved in this case.

FIGS. 2 to 8, 9 to 15 and 16 to 22 respectively illustrate graphs which represent the system voltage 7, the dispersion over time of the system voltage 7, the output power 15 (or measured value 11), the dispersion over time of the output power 15, the control current, the individual phase currents or a system factor as considered, defined or set according to forms of embodiment of the present invention. In all the graphs, time is plotted on the x-axis, and the magnitude of the electrical parameter is plotted on the y-axis.

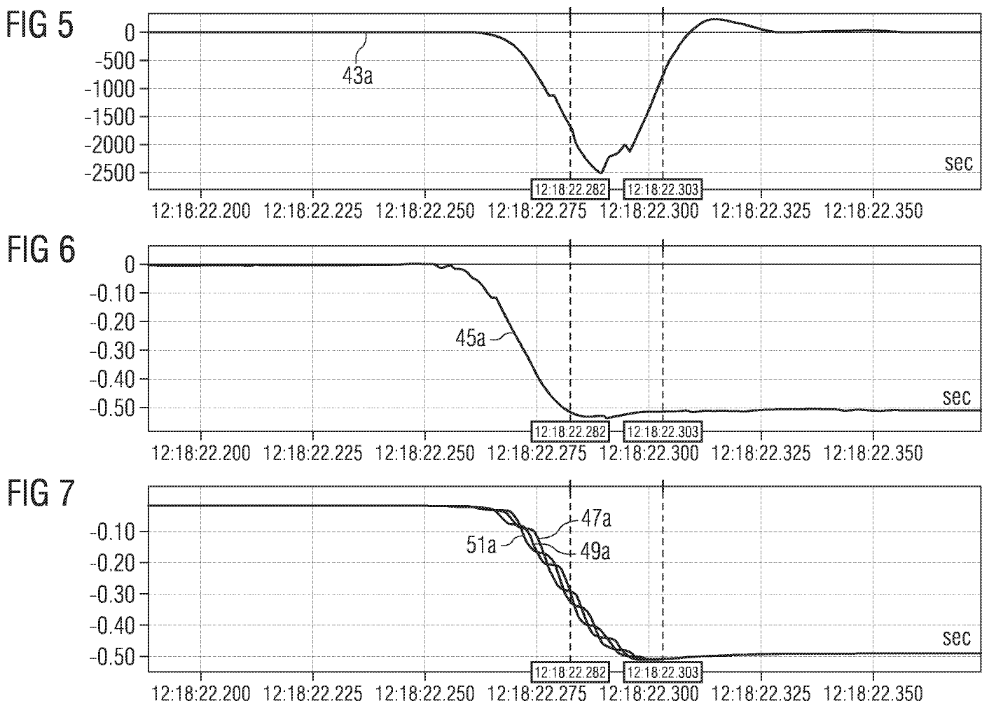

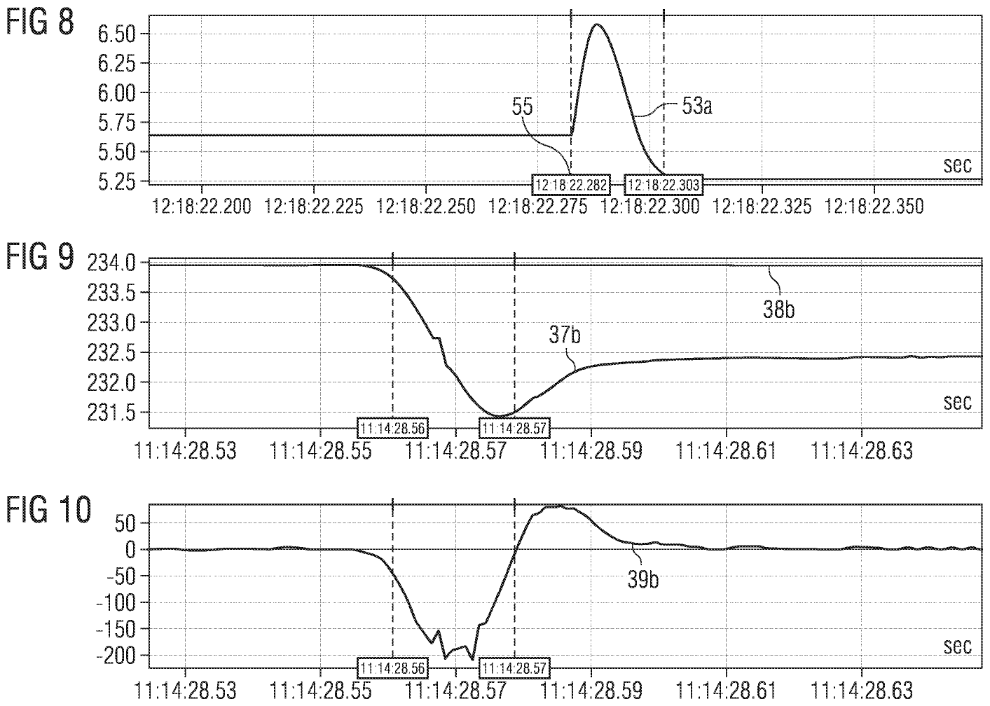

The curves 37a, 37b, 37c in FIGS. 2, 9 and 16 illustrate the characteristic of the system voltage 7. In FIGS. 2, 9 and 16, a target value 38a, 38b, 38c of the system voltage is additionally plotted. The curves 39a, 39b and 39c in FIGS. 3, 10 and 17 respectively illustrate the dispersion of the system voltage over time. The curves 41a, 41b and 41c in FIGS. 4, 11 and 18 respectively illustrate the output power 15, particularly reactive power. The curves 43a, 43b and 43c in FIGS. 5, 12 and 19 illustrate the dispersion over time of the reactive power output by the reactive power device. The curves 45a, 45b and 45c illustrate the control current in FIGS. 6, 13 and 20. The curves 47a, 49a, 51a, 47b, 49b, 51b and 47c, 49c and 51c illustrate the converter currents of the three phases A, B and C in FIGS. 7, 14 and 21. Finally, the curves 53a, 53b and 53c illustrate a system factor in FIGS. 8, 15 and 22.

In response to a rise in the system voltage in FIGS. 2 and 3, the system responds with a reduction in the output of reactive power, according to FIGS. 4 and 5. At the point of strongest decline in the variation of the system voltage, at a time point 55, the system factor of the curve 53a rises substantially, achieves a maximum and declines again, immediately the voltage variation falls back below a threshold value.

FIGS. 23, 24, 25, 26 and 27 illustrate further curves 57, 59, 61, 63 and 65, which represent the system voltage, the control current, reactive power, SCL or an amplification, as considered, measured or set according to forms of embodiment of the present invention.

FIGS. 28 and 29 illustrate curves 67 and 69 respectively, which represent the temporal characteristic of output power or the temporal characteristic of the system voltage. The abscissa in FIG. 28 represents the value of the variation in reactive power and in FIG. 29 represents the variation in voltage. If a concordant variation in both the power output and the system voltage is observed, it can be concluded that the control installation itself is responsible for the variation in voltage in the grid. This concordant behavior is present if, e.g. the voltage reduces and the power reduces simultaneously, or if the voltage increases and the power also increases simultaneously.

Only if a concordant behavior of this type is observed can a short-circuit power, which is calculated from a relationship of changes over time in both the system voltage and in the reactive power output, be employed for the calculation of a control parameter. If this is not the case, the measured value is discarded, and the grid short-circuit equivalent determined at the most recent time point is employed.

1-10. (canceled)

11. A method for controlling an electric voltage of a grid by a reactive power device which is connected to the grid, which method comprises the steps of:
determining a first change over time of a previous voltage on the grid;
determining a second change over time of a previous reactive power previously output into the grid by the reactive power device; and
subsequently outputting reactive power into the grid by means of the reactive power device, the reactive power being determined in accordance with the first and second changes over time.

12. The method according to claim 11, wherein the outputting of the reactive power which is output subsequently by the reactive power device comprises the further substeps of:
setting at least one controller parameter of a controller of the reactive power device in accordance with the first and second changes over time, wherein the controller receives a deviation of the previous voltage from a target value as an input;
outputting by the controller a control value for the reactive power to a converter of the reactive power device;
generating the reactive power by the converter and injecting the reactive power into the grid.

13. The method according to claim 12, wherein the setting of the at least one controller parameter further comprises the following substeps:
determining a previous short-circuit power on the grid, in accordance with the first and second changes over time; and
determining the at least one controller parameter on a basis of the previous short-circuit power thus determined.

14. The method according to claim 13, wherein the previous short-circuit power of the grid is determined in accordance with a respective magnitude and/or symbol of first changes over time of the previous voltage on the grid and the second change over time in the previous reactive power output by the reactive power device.

15. The method according to claim 13, wherein the previous short-circuit power of the grid is determined in accordance with a previous relationship of first changes over time in a system voltage with the second change over time in the previous reactive power output of the reactive power device, by an application of a determination logic which is determined or verified on the basis of a simulation.

16. The method according to claim 15, wherein the determination logic further comprises the following substeps of:
weighting of the previous relationship relative to a further previous short-circuit power which is higher, where a greater of at least one of the magnitudes of the first changes over time in a previous system voltage and/or of the second change over time in the previous reactive power previously output by the reactive power device; and/or
employment of the previous relationship or a weighted previous relationship for the determination of the previous short-circuit power, where a magnitude of the first changes over time in the previous system voltage and/or of the second change over time in the previous reactive power previously output by the reactive power device exceeds a respective threshold value; and/or
where a symbol of the first change over time in the previous system voltage and a symbol of the second change over time in the previous reactive power previously output by the reactive power device are the same, wherein the reactive power output by the reactive power device is subject to a rising valuation, in an event of an increasing injection of capacitive reactive power.

17. The method according to claim 16, wherein the previous short-circuit power KSL_previous, where ΔQ/ΔV>0, is determined as follows:
KSL_previous=((1−w)*KSL_further-previous+w*ΔQ_previous/ΔV_previous)/2
where:
ΔV_previous is the first change over time in the previous voltage on the grid;
ΔQ_previous is the second change over time in the previous reactive power previously output by the reactive power device;
KSL_previous is the previous short-circuit power of the grid;
KSL_further-previous is the further previous short-circuit power of the grid; and
w is a weighting factor between zero and one.

18. The method according to claim 17, wherein the ΔQ0, ΔV0 are threshold values, and:
w=0, where ΔV<ΔV0 and/or ΔQ<ΔQ0,
w=1, where ΔV>=ΔV0 and/or ΔQ>=ΔQ0, or
where w is proportional to (ΔQ−ΔQ0).

19. The method according to claim 11, wherein:
the first and second changes over time are determined in a time interval which lies between 100 μs and 10 ms;
the method is repeated cyclically; and
the converter comprises a switch mode voltage converter.

20. The method according to claim 12, wherein:
the at least one controller parameter is controller amplification; and
the converter is a reactive power compensation installation of the reactive power device.

21. The method according to claim 13, wherein the at least one controller parameter determined on the basis of the previous short-circuit power is further determined in consideration of an influence of other voltage controllers which are active in the grid.

22. The method according to claim 13, wherein the previous short-circuit power of the grid is determined in accordance with a respective magnitude and/or symbol of first changes over time of the previous voltage on the grid and the second change over time in the previous reactive power output by the reactive power device, and on a basis of a further previously determined short-circuit power of the grid.

23. The method according to claim 15, wherein parameters of the determination logic are maintained constant over a short-circuit power range from 50 MVA to 20 000 MVA.

24. The method according to claim 11, wherein:
the first and second changes over time are determined in a time interval which lies between 500 μs and 5 ms;
the method is repeated cyclically; and
the converter comprises a switch mode voltage converter.

25. The method according to claim 11, which further comprises setting a speed of control in consideration of other voltage controllers which are present in the grid.

26. A device for controlling an electric voltage of a grid, the device comprising:
a reactive power device being connectable to the grid;
a controller configured to determine a first change over time in a previous voltage on the grid, and to determine a second change over time in a previous reactive power which has previously been output into the grid by said reactive power device; and
said reactive power device configured to output a reactive power into the grid which is determined in accordance with the first and second changes over time.
